(19) United States
(12) Patent Application Publication
(10) Pub. No.: US 2018/0000144 A1
(43) Pub. Date: Jan. 4, 2018

(54) Liquid Embedded Nutritional Bar

(71) Applicant: Alfonzo Hawkins, Yorktown, VA (US)

(72) Inventor: Alfonzo Hawkins, Yorktown, VA (US)

(21) Appl. No.: 15/401,395

(22) Filed: Jan. 9, 2017

Related U.S. Application Data
(60) Provisional application No. 62/204,568, filed on Aug. 13, 2015.

(51) Int. Cl. A23L 33/10; A23P 10/30; A23P 30/10

(52) U.S. Cl. CPC A23L 33/10; A23P 30/10; A23P 10/30; A23V 2002/00

(57) ABSTRACT

Provided is a nutritional bar which includes a body portion having a protein or energy-filled food, and at least one embedded portion which is embedded within the body portion that includes liquid and/or gel for consumption. The nutritional bars can be snack bars, energy bars or dietary bars, for example, and enable a consumer to have an additional source for water consumption as recommended.

### I. TECHNICAL FIELD

The technical field relates generally to a nutritional bar. In particularly, the present invention relates to liquid-embedded nutritional bar that provides necessary liquid (e.g., water) for consumers.

### II. BACKGROUND

Today, nutritional bars are very popular. Consumers typically eat these bars to curb their appetite in between meals, or act as a meal substitute. Some nutritional bars include cereal, grains, oats, chocolate, and fruit, and other high energy or protein food. There are various types such as Protein bars, Food bars, Endurance & Energy bars, and Sports nutritional bars. Consumers such as campers and military personnel also may consume these bars as a part of their daily diet. However, the consumers may not be in a location which will afford them an opportunity to have drinking water or other liquids. Therefore, it is desirable to provide a nutritional bar which includes liquid for consumption.

### III. SUMMARY OF THE EMBODIMENTS

The present invention provides a nutritional bar which includes a body portion comprising a protein or energy-filled food, and at least one embedded portion which is embedded within the body portion and comprising liquid for consumption.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### IV. DESCRIPTION OF THE DRAWINGS

FIG. 1 illustrates a nutritional bar that can be implemented within one or more embodiments of the present invention.

FIG. 2 illustrates a nutritional bar that can be implemented within one or more alternative embodiments of the present invention.

FIG. 3 illustrates a nutritional bar that can be implemented within one or more alternative embodiments of the present invention.

FIG. 4 illustrates a layering formation of the nutritional bars shown in FIGS. 1 through 3 that can be implemented within one or more embodiments of the present invention.

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### V. DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

Exemplary embodiments of the present invention provides a nutritional bar which includes a body portion comprising protein or energy-filled food, and at least one embedded portion which is embedded within the body portion and comprising liquid for consumption. The nutritional bar described in embodiments of the present invention is provided to help athletes, outdoorsman, and/or military personnel obtain the proper combination of protein, water (H₂0), fiber, minerals, vitamins, and electrolytes needed at any given to time assist with peak performance and/or survival. Thus, the nutritional bar of the present invention can be a survival bar.

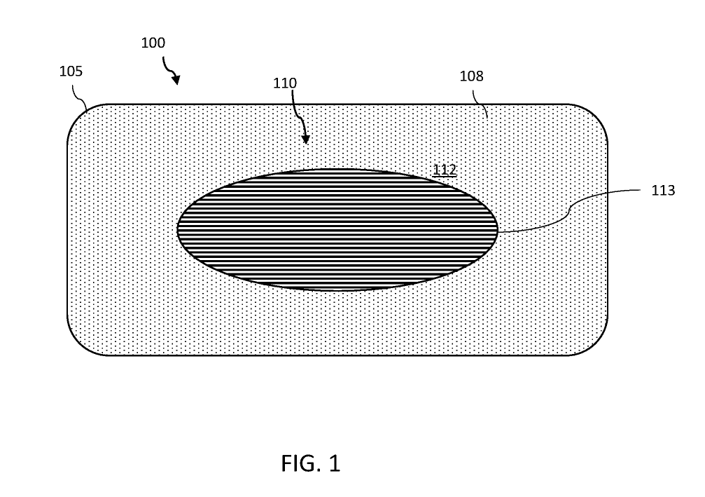

FIG. 1 illustrates a nutritional bar that can be implemented within one or more embodiments of the present invention. According to embodiments of the present invention, the nutritional bar can be one of a snack bar, energy bar, dietary bar or other nutritional and dietary supplements formed and packaged in a bar form.

As shown in FIG. 1, a nutritional bar 100 which includes a body portion 105 comprising a protein or energy-filled food 108, and at least one embedded portion 110 which is embedded within the body portion 105 and comprising liquid or gel 112 for consumption and a housing or film 113 for housing the liquid therein. The film 113 itself can be formed of a material infused with electrolytes or other components similar to that of the liquid or gel 112 encapsulated within the film 113.

The protein or energy-filled food 108 may include cereal, grain, oats, fruit, candy, chocolate or any other protein or energy-filled food. The present invention is not limited to the protein or energy-filled food being any particular type of food and may vary accordingly. The nutritional bar 100 is held together by saturated gums, proteins or fibers or any other suitable consumable product which prevents the nutritional bars 100 from falling apart during the baking process.

The liquid or gel 112 may be water, juice, electrolytes or any other type of consumable liquid or gel. The liquid may for example, be in various flavors such as fruits or vegetable flavors, for example. The present invention is not limited to the liquid or gel 112 being any particular type of liquid or flavor and may vary accordingly.

According to one or more embodiments, the body portion 105 may be of any shape or size.

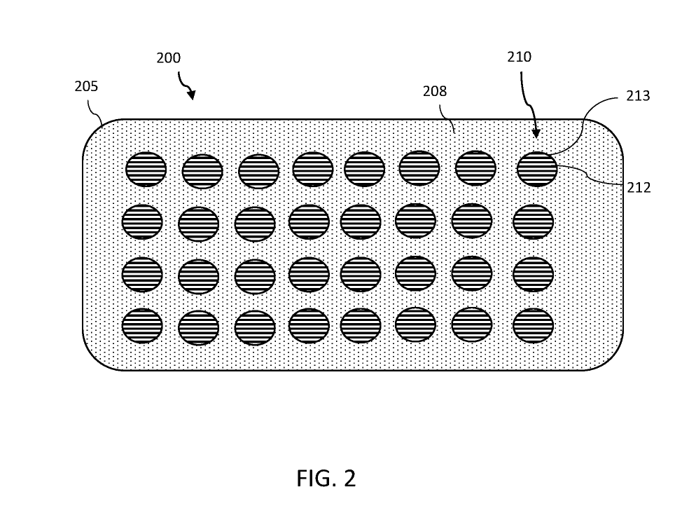

The embedded portion 110 may be of any shape and size. Further according to other embodiments of the present invention, the nutritional bar may comprise a plurality of embedded portions as shown in FIG. 2.

The nutritional bar 100 may also include optional top layers such as yogurt, preserves, cereal layer, an additional grain layer etc., as desired.

FIG. 2 illustrates a nutritional bar 200 that can be implemented within one or more alternative embodiments of the present invention. Some components of the nutritional bar 200 are the same as that of the nutritional bar 100 therefore a detailed description thereof has been omitted, for the purposes of illustration.

As shown in FIG. 2, the nutritional bar 200 comprises a body portion 205 including a protein or energy-filled food 208, and a plurality of embedded portions 210 filled with a liquid and/or gel 212 comprising water, juice or any other liquid and comprising a housing or film 213 for housing the liquid and/or gel 212 therein and surrounding the liquid and/or gel 212.

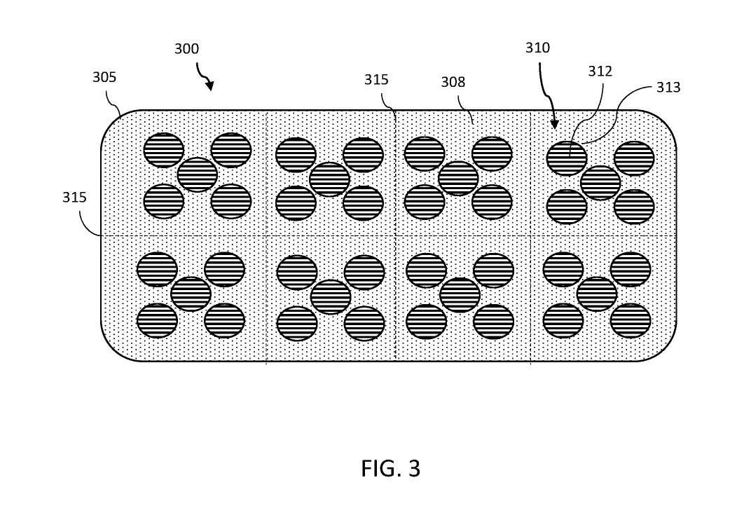

As shown in FIG. 3, the nutritional bar 300 comprises a body portion 305 including a protein or energy-filled food 308, and a plurality of embedded portions 310 filled with a liquid and/or gel 312 comprising water, juice or any other liquid and comprising a housing or film 313 for housing the liquid and/or gel 312 therein and surrounding the liquid and/or gel 312. The nutritional bar 300 further includes a plurality of perforated sections 315 which can be formed vertically and/or horizontally through the nutritional bar 300. The perforated sections 315 enable a user to break a portion(s) of the nutritional bar 300 at a time, for consumption and save the remaining portions if so desired.

Further in FIG. 3, there are a specific number (e.g., five) of the embedded portions 310 included within each perforated section 315. The present invention is not limited to a particular number of embedded portions 310 within each perforated section 315 and may vary accordingly.

The embodiments of the present invention as shown in FIGS. 1, 2, 3 provide the embedded portions 110, 210, 310 which are formed of a material which houses the liquid therein. The housing or film 113, 213 and 313 comprises a protective covering to prevent the liquid or gel 112, 212 and 313 therein from penetration during the baking process and prior to consumption by a consumer. The embedded portions 110, 210 and 310 may be liquid-filled or gel-filled balls which burst when bitten into by the consumer. The housing or film 113, 213 and 313 may be formed of a translucent and/or chewy material.

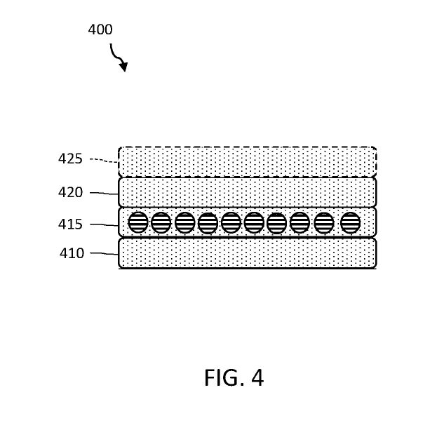

FIG. 4 includes a layering formation 400 that can be implemented within nutritional bars 100, 200 and 300 shown in FIGS. 1, 2 and 3. As shown in FIG. 4, the layering formation 400 includes a first layer 410, a second layer 415 housing the embedded portions 110, 210, or 310, a third layer 420 and an optional fourth layer 425. The first layer 410 is the protein or energy-filled food layer which can include a grain and/or fruit mixture including a plurality of grains, fruits nuts etc. The second layer 415 includes another mixture layer (or second energy-filled food layer) including olive oil or any other type of substance to house the embedded portions 110, 210 or 310 therein along with additional grain and/or fruit mixture, The third layer 420 includes another mixture layer (or a third energy-filled food layer). Next, the optional fourth layer 425 can include a yogurt, fruit or other type of layer as desired.

The nutritional bars 100, 200 and 300 are formed via a manufacturing process and are baked at a temperature suitable for the purposes set forth herein. The manufacturing process can be an automated process using automated equipment and/or computer equipment for design and forming the layering formation including the embedded portions of the nutritional bar. The embedded portions may be input during the layering formation or injected after completion of the layering formation. The embedded portions are spaced apart a predetermined distance from each other within the nutritional bar, to ensure that every portion of the nutritional bar includes at least one embedded portion. Each nutritional bar provides a predetermined amount of water or other liquid for consumption. The predetermined amount of water or other liquid can be determined during the manufacturing process.

The nutritional bar of the present invention solves the problems of dehydration and malnutrition by providing water, for example, therein, to assist with proper digestion and help prevent ketosis. The consumer also does not have to carry as much bulk or heavy items holding water or other drinks when consuming these nutritional bars.

This written description uses examples to disclose the invention, including the best mode, and also to enable any person skilled in the art to practice the invention, including manufacturing operations. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A nutritional bar comprising:
a body portion comprising a protein or energy-filled food; and
at least one embedded portion which is embedded within the body portion and comprising liquid and/or gel for consumption, and a housing or film for housing the liquid therein.

2. The nutritional bar of claim 1, wherein the liquid and/or gel is encapsulated by the housing or film.

3. The nutritional bar of claim 2, wherein the protein or energy-filled food may include cereal, grain, oats, fruit, candy, chocolate or any other protein or energy-filled food.

4. The nutritional bar of claim 2, wherein the nutritional bar 100 is held together by saturated gums, proteins or fibers.

5. The nutritional bar of claim 2, wherein the liquid and/or gel includes water, juice, electrolytes or any other type of consumable liquid or gel.

6. The nutritional bar of claim 2, wherein the housing or film comprises a protective covering to prevent the liquid and/or gel therein from penetration during a baking process thereof.

7. The nutritional bar of claim 1, wherein the at least one embedded is a liquid-filled ball or a gel-filled ball which burst when bitten into by the consumer.

8. The nutritional bar of claim 1, wherein the housing or film is formed of a translucent and/or chewy material.

9. A nutritional bar comprising:
a body portion including a protein or energy-filled food; and
a plurality of embedded portions filled with a liquid and/or gel, and a housing or film for housing the liquid therein.

10. The nutritional bar of claim 9, wherein the liquid and/or gel is encapsulated by the housing or film.

11. The nutritional bar of claim 9, wherein the protein or energy-filled food may include cereal, grain, oats, fruit, candy, chocolate or any other protein or energy-filled food.

12. The nutritional bar of claim 9, wherein the nutritional bar 100 is held together by saturated gums, proteins or fibers.

13. The nutritional bar of claim 9, further comprising:
a plurality of perforated sections formed throughout the nutritional bar, to enable a user to break a portion(s) of the nutritional bar.

14. The nutritional bar of claim 13, wherein the plurality of perforated sections are formed vertically throughout the nutritional bar.

15. The nutritional bar of claim 13, wherein the plurality of perforated sections are formed horizontally throughout the nutritional bar.

16. The nutritional bar of claim 10, wherein the plurality of perforated sections each comprise a specific number of the embedded portions.

17. A method for manufacturing a nutritional bar, the method comprising:
forming a first layer of a protein or energy-filled food;
forming a second layer housing a plurality of embedded portions therein filled with liquid and/or gel, and a housing or film for housing the liquid and/or gel therein; and
forming a third layer of a protein or energy-filled food.

18. The method of claim 17, wherein the first layer, the second layer, and the third layer or formed by molding or pressing processes.

19. The method of claim 17, wherein the second layer is formed of an energy-filled food with the plurality of embedded portions spaced throughout the second layer.

20. The method of claim 17, further comprising:
forming a plurality of perforated sections formed throughout the nutritional bar, to enable a user to break at least a portion of the nutritional bar, wherein each of the perforated sections comprising a specific number of embedded portions therein.
